(19) United States
(12) Patent Application Publication
(10) Pub. No.: US 2015/0274981 A1
(43) Pub. Date: Oct. 1, 2015

(54) DUAL FUNCTION LANTHANIDE COATINGS

(71) Applicant: Skyworks Solutions, Inc., Woburn, MA (US)

(72) Inventor: Michael David Hill, Frederick, MD (US)

(21) Appl. No.: 14/736,179

(22) Filed: Jun. 10, 2015

Related U.S. Application Data
(63) Continuation-in-part of application No. 14/609,856, filed on Jan. 30, 2015, now abandoned.
Application No. 14/609,856 is a continuation of application No. 13/241,118, filed on Sep. 22, 2011, now Pat. No. 8,945,729.
(60) Provisional application No. 61/385,275, filed on Sep. 22, 2010.

(51) Int. Cl. C09D 1/00; C08K 3/22; B05D 1/12

(52) U.S. Cl. CPC C09D 1/00; B05D 1/12; C08K 3/22; C08K 2003/221; C08K 2003/2265; C08K 2003/2227; C08K 2003/2289; C08K 2003/2293; C08K 2003/2248

(57) ABSTRACT

Disclosed herein are embodiments of dual function coatings having at least one lanthanide element incorporated therein, and methods of manufacturing such coatings. The dual function coatings can act as both an RF absorber and a thermal barrier. The coatings can be incorporated into different applications, such as the manufacturing of aircrafts and jet engines.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

The present disclosure generally relates to compositions for coating metallic components, and in particular, relates to thermal barrier coatings with RF absorbing properties that can be used for aircraft engine components.

2. Description of the Related Art

Thermal barrier coatings are commonly applied to aircraft engine components and other metallic parts that operate at elevated temperature conditions. The coatings insulate the aircraft engine components from heat, thus allowing the components to operate under higher temperatures, which in turn can improve engine efficiency. Thermal barrier coatings also protect the engine components, such as turbine blades and combustion chambers, from oxidation and thermal fatigue that may be caused by prolonged thermal exposure. For example, yttria modified zirconia is commonly used as a thermal barrier coating because of the favorable heat insulating properties of zirconia. While a number of different thermal barrier coating materials have been developed for aircraft engine components, there is a continuing need for coatings that are stable at higher temperature conditions.

For military aircrafts, it may also be desirable to apply a radio frequency (RF) absorber material on the engine components to evade radar detection. A layer of RF absorber such as Ferrite 50 or TT2-111R, available from Trans-Tech Inc. of Adamstown, Md., is often applied to the turbine blades in addition to the thermal barrier coating. However, the additional layer adds weight to the aircraft and requires an additional manufacturing step. As such, there is a need to find an effective thermal barrier coating that can operate at higher temperature conditions and there is also a need for reducing the layers of coating on aircraft engine components.

### SUMMARY

In one aspect, embodiments disclosed herein include compositions that serve, among other things, the dual function of a thermal barrier and an RF absorber. The compositions can be applied as a single layer to an aircraft engine component, thus reducing the weight of the aircraft and eliminating an extra coating step in the manufacturing process. Coating materials comprising the compositions can be applied to metals, such as engine components. The coating materials are designed to protect the metal underneath from the high temperatures generated during engine operation, and also to absorb or scatter radiation which may incumbent on the metal during operation.

Some embodiments of a thermal barrier and RF absorber composition have magnetic activity, such as paramagnetic, ferromagnetic, or ferrimagnetic, at temperatures in the range of about 800° C. to about 1,000° C. The composition may have strain tolerance when applied as a coating on a metallic turbine blade. The composition may have a thermal expansion coefficient of about 10×10⁻⁶/° C. or above. In some embodiments, the thermal expansion coefficient of the material may match or be similar to that of the metal of the aircraft engine turbine blades to which it may be applied. The material may melt congruently so that it may be plasma sprayed in the molten phase and cooled to form the desired phase assemblages. The material may have a thermal conductivity similar to or less than that of yttria stabilized zirconia.

In various embodiments, the dual function thermal barrier coating material generally comprises a Lanthanide (Ln)-Aluminum (Al)-Iron (Fe)-Oxygen (O) system. The Lanthanide series comprises lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). In one embodiment, the thermal barrier coating material comprises a composition that is represented by the formula LnAl_{1-x-y}FeₓM_{y}O₃ or the formula LnAl_{11(1-x-y)}FeₓM_{y}O₁₈, where 0<x<1 and 0<y<0.5. In one implementation, Ln can be Lathanum (La), Praseodymium (Pr), Neodymium (Nd), Samarium (Sm), or a combination thereof; M can be Cobalt (Co), Nickel (Ni), or Copper (Cu), or a combination thereof. In some embodiments, the dual function thermal barrier coating material may comprise a two-phased composite of LnAl_{1-x-y}FeₓM_{y}O₃ and LnAl_{11(1-x-y)}FeₓM_{y}O₁₈.

In some aspects, embodiments disclosed herein include metal substrates that incorporate the dual function thermal barrier of some embodiments. In some embodiments, the metal substrates can be part of an aircraft engine component such as the turbine blades.

### BRIEF DESCRIPTION OF THE DRAWINGS

FIG. 1 illustrates the crystal structure of a perovskite with the general property ABX₃.

FIG. 2 illustrates the crystal structure of a magnetoplumbite cell with the chemical structure BaFe₁₂O₁₉.

FIGS. 3A-B illustrate a comparison of a paramagnetic material inside of a magnetic field and outside of a magnetic field.

FIG. 4 illustrates the electron shell diagram of an atom of cobalt.

FIG. 5 illustrates a standard stress strain curve.

FIG. 6 illustrates a plastic zone surrounding a crack during crack propagation.

FIG. 7 illustrates crack propagation in a material and an example of crack bridging.

FIG. 8 illustrates a plasma sprayer depositing a material on a surface.

FIG. 9 illustrates the effect of the thermal expansion coefficient on two different materials connected together.

FIG. 10 is a flow chart illustrating a method of manufacturing a dual function coating composition with thermal barrier properties and with RF absorbing capabilities according to some embodiments of the present disclosure.

FIG. 11 illustrates a component incorporating a dual function coating composition with thermal barrier properties and with RF absorbing capabilities according to some embodiments of the present disclosure.

FIG. 12 illustrates an aircraft jet engine incorporating a dual function coating composition with thermal barrier properties and with RF absorbing capabilities according to some embodiments of the present disclosure.

FIG. 13 illustrates a turbine, for example within a jet engine, incorporation a dual function coating composition with thermal barrier properties and with RF absorbing capabilities according to some embodiments of the present disclosure.

FIG. 14 illustrates a plane incorporating a dual function coating composition with thermal barrier properties and with RF absorbing capabilities according to some embodiments of the present disclosure.

### DETAILED DESCRIPTION

Disclosed herein are coating compositions that have both thermal barrier and RF absorbing properties such that a single layer of the coating composition would be sufficient for protecting aircraft engine components or other metallic parts that operate under high temperature conditions and that may require RF absorption or scattering.

Aircraft engine components, such as turbine blades and combustion chambers, are typically coated with a layer of thermal barrier coating. The thermal barrier coating serves to prevent the metallic components from heating past its melting point during engine operation. A coating such as yttria modified zirconia can be applied to the turbine blades as a thermal barrier. In addition to the thermal barrier layer, another coating having RF absorbing capabilities is also typically applied to the engine component to prevent radar detection. However, having to add a second coating with RF absorbing capabilities on top of a thermal barrier layer can increase the weight of the components, such as aircraft engine components, increasing the overall fuel costs and reducing efficiency.

Thermal barrier coatings are typically used on metallic surface operating at extreme temperatures, or temperatures that would affect the physical characteristics of the underlying metal. The coatings are typically used to protect against large heat loss or gain. A coating is applied to the metallic surface which insulates the metallic surface from large amounts of heat, as well as from prolonged exposure to heat. The coatings allow for the metallic surfaces to be used at higher than normal operating temperature. For example, thermal barrier coatings may have low thermal conductivity, good erosion resistance, and phase stability. Thermal barrier coatings can be produced in numerous ways such as, but not limited to, plasma spraying, direct vapor deposition, and electron beam physical vapor deposition.

### Dual Function Coating Composition

Certain embodiments of a dual function coating composition would be able to protect components, such as, but not limited to, aircraft engine components, from heat and RF signals while also reducing the overall weight of the components. Reducing the overall weight occurs because the components would only have to be coated once as the thermal barrier and RF absorber are a part of the same coating composition. Having a dual function coating would also reduce the time spent preparing components.

Some embodiments of the dual function coating composition generally comprise one or more crystalline structures of the Lanthanide-Aluminum-Iron-Oxygen (Ln—Al—Fe—O) system. The crystalline structures may include, for example, perovskites and magnetoplumbites. The Lanthanide series comprises lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

In one embodiment, the coating composition may be represented by the formula LnAl_{1-x-y}FeₓM_{y}O₃ or LnAl_{11(1-x-y)}FeₓM_{y}O₁₈, where 0<x<1 and 0<y<0.5. In one implementation, Ln can be Lathanum (La), Praseodymium (Pr), Neodymium (Nd), Samarium (Sm), or a combination thereof; and M can be Cobalt (Co), Nickel (Ni), or Copper (Cu), or a combination thereof. In one implementation, the dual function coating material may comprise a two-phased composite of LnAl_{1-x-y}FeₓM_{y}O₃ and LnAl_{11(1-x-y)}FeₓM_{y}O₁₈. Although the parent aluminate structures LnAlO₃ and LnAl₁₁O₁₈ have been used as thermal barrier coating materials, the two-phased composite of LnAl_{1-x-y}FeₓM_{y}O₃ and LnAl_{11(1-x-y}) FeₓM_{y}O₁₈ surprisingly shows exceptional strain tolerance.

Furthermore, La, Pr, Nd and Sm are selected to be included in embodiments of the above crystalline structures because each does not form an aluminate garnet (Ln₃Al₅O₁₂) which is intermediate in alumina content between the perovskite and the magnetoplumbite phases, and decomposes by undesirable peritectic melting. Another advantage to the two-phased composite of LnAl_{1-x-y}FeₓM_{y}O₃ and LnAl_{11(1-x-y)}FeₓM_{y}O₁₈ is that it improves compatibility with the thermally grown aluminum oxide on bonded nickel based superalloys which are used in some aircraft engine components. Superalloys are high performance alloys which have high mechanical strength and creep resistance at elevated temperatures.

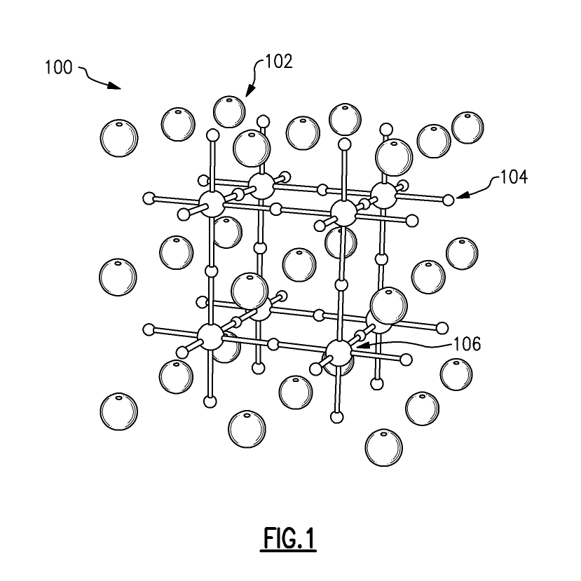

FIG. 1 illustrates an example crystal structure of a perovskite. A material has a perovskite structure if it has the same crystal structure as calcium titanium oxide (CaTiO₃). Typically, a perovskite structure has a general chemical composition of ABX₃, wherein A 102 and B 104 are both cations, though of different sizes, and X 106 is an anion that bonds to both A 102 and B 104. The A cations 102 are located in the corners, the B atoms 104 are located in a body centered position and the X anions 106 sit in the face centered positions. Typically, the A cations 102 are larger than the B cations 104. Because the perovskite structure has stringent size requirements of the cations, the crystal can become distorted, by incorrect element placement, into structures with a lower symmetry and structural weakness. If distortion does occur, the number of cations tends to be reduced within the crystal structure. A perovskite structure can also be complex, wherein the structure contains two different types of B cations 104.

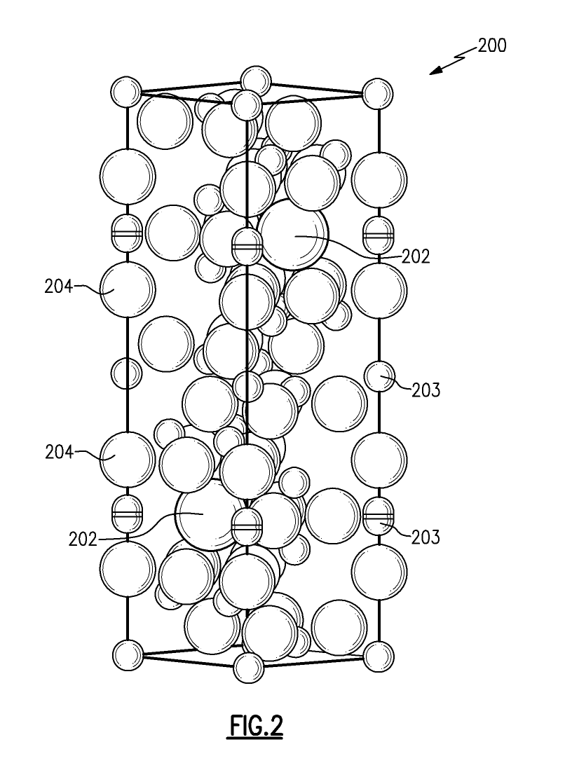

FIG. 2 illustrates an example crystal structure of a magnetoplumbite cell 200 with the formula BaFe₁₂O₁₉. The barium atoms are located at the 202 positions, the iron atoms are located at the 203 positions, and the oxygen atoms are located at the 204 positions. Additionally, in some embodiments, the magnetoplumbite structure has crystallographic sites available which show diverse co-ordination spheres. Hexahedral, tetrahedral, and octahedral sites are available for Fe and Co in some embodiments of the magnetoplumbite structure, which leads to a variety of magnetic interactions.

The perovskite and magnetoplumbite structures are preferably compatible with one another, and may be used individually or may be combined as a two phase mixture. Depending on the desired properties, the structures can either be combined or left as individual structures.

### Magnetic Properties

Some embodiments of the coating composition have magnetic activity, such as paramagnetic, ferromagnetic, or ferrimagnetic activity.

Ferromagnetic materials form permanent magnets and are the strongest form of magnetism. Ferromagnetic materials can be magnetized by an external magnetic field and remain magnetized even upon removal of the external magnetic field, thereby making them useful in motors, generators, transformers, and electromagnets. Ferromagnetic activity is caused by electron spin and alignment.

Electrons within an atom have spin and, combined with the electron's electric charge, results in a magnetic dipole moment. This magnetic dipole moment creates a magnetic field, albeit a small one. However, when all of the magnetic dipole moments in a material are added up, they can show a macroscopic effect. Even with electrons creating a magnetic dipole moment, magnetism only occurs in materials without a filled electron shell. If the electron shell is filled, the magnetic dipole moment is a net of 0 because the electrons pair up and balance each other out. Therefore, ferromagnetism only occurs in materials with a partially filled shell. In a ferromagnetic material, the magnet dipole moments of the electrons in the partially filled shell can be aligned parallel to an external magnetic field. Also, in a ferromagnetic material, the magnetic dipole moments can spontaneously align, causing spontaneous magnetization, even when no magnetic field is applied.

Another factor in creating a ferromagnetic material is the exchange interaction. In many situations, nearby magnetic dipoles will align in opposite directions so the overall magnetic field will cancel out. However, this is a weak effect which can be overcome by other forces, such as simple thermal fluctuation. In certain materials, such as ferromagnetic materials, an effect known as exchange interaction overcomes the force to align nearby magnetic dipoles in the same direction. The exchange interaction is related to the Pauli exclusion principle, which states that electrons with the same spin cannot be in the same position. Under certain conditions, parallel-spin states for electrons are more stable than the anti-parallel spin states, because the electrons become more separated in their shell, thereby aligning magnetic moments. Ferromagnetic materials contain a much stronger exchange interaction, thus leading to their magnetic properties.

A property that affects ferromagnetic materials is magnetorestriction. Magnetorestriction causes the material to change dimensions during magnetization. Magnetorestriction occurs because ferromagnetic materials can be divided into many different magnetic domains. These domains each have their own uniform magnetization, wherein the magnetic moments of all of the atoms in a domain are aligned with each other in the same direction. As a ferromagnetic material is made up of many different magnetic domains, magnetizing the domains causes each of the domains to slightly shift. The overall net shift of the individual domains causes the material's change in dimensions. The dimensional change of a material in a magnetic field can lead to strain on the structure, which can reduce desirable properties within a system. The dimensional change can also cause losses due to frictional heating of the material during the change of shape.

Ferrimagnetic materials occurs when the magnetic moments of atoms on different sublattices are opposed and unequal. Therefore, like ferromagnetism, spontaneous magnetism can still occur. However, unlike ferromagnetic materials, ferrimagnetic materials have a temperature point where the net magnetic moment is zero. This point is known as the magnetization compensation point. Ferrimagnetism occurs in materials such as ferrites and magnetic garnets.

Ferrimagnetic materials have high resistivity. The more resistive a material is, the more strongly it opposes the flow of electric current. Electrical resistivity is defined as:

$$ρ = \frac{E}{J}$$

where ρ is the resistivity, E is the magnitude of the electric field and J is the magnitude of the current density. Ferrimagnetic materials also have anisotropic magnetic properties, therefore the magnetic activity of a ferrimagnetic material is directionally dependent.

In dual function coating compositions, the crystalline structures are preferably selected for their ability to preserve paramagnetic behavior at high temperatures, which makes the dual function coating composition a good high temperature RF absorber. For example, in the perovskite structure, both iron and cobalt show octahedral co-ordination and may show multiple oxidation states, each with an unfilled 3d electron shell, which enhances the magnetic properties. Electron spin, due to an unfilled 3d electron shell, is a source of magnetic effects within an atom. In paramagnetic materials, at least one electron is not paired with another electron. Therefore, once placed in a magnetic field, the atom is attracted to the magnetic field.

A paramagnetic material is attracted to a magnetic field only in the presence of an external magnetic field. The magnetic moment induced by the external magnetic field is linear in the field. When not in a magnetic field, the paramagnetic material contains no magnetic properties, unlike a ferromagnetic material. Because paramagnetic materials are attracted to a magnetic field, they are considered to have a positive magnetic susceptibility. However, the magnetic moment induced by the application of an external magnetic field is rather weak.

The molecules which make up a paramagnetic material have permanent magnetic moments, regardless of whether an external magnetic field is applied. However, the magnetic moments do not interact with each other within the material, and are therefore randomly directed, producing a net magnetic moment of 0.

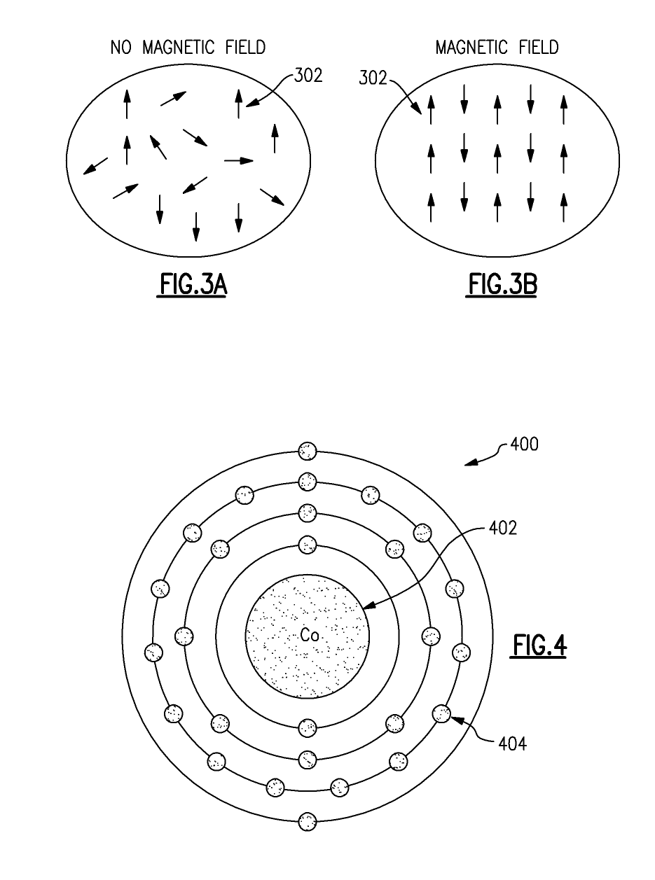

FIGS. 3A-B illustrate the effect of a paramagnetic material inside and outside of a magnetic field. When placed outside of a magnetic field, as illustrated in FIG. 3A, the magnetic dipoles 302 of the atoms point in random direction. However, when the paramagnetic material is placed inside of a magnetic field, as illustrated in FIG. 3B, the magnetic dipoles 302 become aligned. Because the number of electrons are uneven, the number of electrons with spins aligned to the magnetic field outnumber those electrons with a spin opposing the magnetic field. Therefore, the paramagnetic material becomes slightly attracted to the magnetic field. However, once the paramagnetic material is removed from the magnetic field, the magnetic dipoles 302 once again randomize due to thermal motion.

Paramagnetic materials usually follow Curie's Law, expressed as the formula:

$$M = 𝒳 H = \frac{C}{T} H$$

wherein M is the resulting magnetization, X is the magnetic susceptibility, H is the auxiliary magnetic field, T is the absolute temperature, and C is the material specific Curie constant. Curie's Law shows that the susceptibility of paramagnetic materials is inversely proportional to the temperature. Therefore, a paramagnetic material typically becomes more magnetic at lower temperatures.

FIG. 4 illustrates a schematic shell structure of cobalt 400 which is useful for its paramagnetic properties in a perovskite structure. The standard cobalt nucleus 402 is formed from 27 protons and 32 neutrons. The cobalt atom also encompasses 27 total electrons 404, contained within 4 energy levels. The first energy level contains 2 electrons 404, the second energy level contains 8 electrons 404, the third energy level contains 15 electrons 404, and the fourth energy level contains 2 electrons 404. Cobalt, in particular, may show a variety of different oxidation states (−1, +1, +2, +3, +4, and +5) each with a high spin, a medium spin, and a low spin state. The numerous states allows for different properties of cobalt to be brought out, such as paramagnetism at high temperatures.

### Strain and Crack Propagation

FIG. 5 illustrates a standard stress strain curve. A stress strain curve is a graphical measurement of a material's mechanical properties. Traditionally, a tensile test is used to create a stress strain curve for a given material. The vertical axis represents stress whereas the horizontal axis represents strain. Stress is defined as the load divided by the cross-sectional area of the material. Strain is defined as the displacement divided by the original length of the material. The yield strength point 502 is the point where a material begins to deform plastically, and cannot be directly recovered to the original dimensions. Until the yield strength point, the stress strain curve moves in a linear manner with a constant slope, known as the Young's modulus. Upon reaching the yield strength point 502, the material begins to strain harder, wherein more stress is necessary to increase strain, and non-recoverable deformation begins to occur. The ultimate tensile strength point 504 is the point in which necking begins to occur and where the cross sectional area of the material begins to decrease at a rapid rate as more strain is applied. The rupture point 506 is where the material would break if strain was continued to be placed on the material. Brittle materials, such as ceramics, tend to have a rupture point 506 much closer to the ultimate tensile strength point 504. A perfectly brittle material would have an identical ultimate tensile strength point 504 and rupture point 506.

In some embodiments, the dual function coating composition has increased strain tolerance. Increased strain tolerance increases the distance between the yield point 502 and the rupture point 506. Therefore, the material can be placed under more stress without fracturing.

Crack propagation is a significant problem in the field of ceramics. Cracks can be formed in many different ways within a material. Sintering generally leaves small pores within a material, which can expand and form into cracks upon stressing. Also, thermal stresses can form cracks within a ceramic material as the heating and cooling of the ceramics can leave spaces within the material or cause stresses resulting in cracks. Even if there are no processing related cracks, cracks can be formed from environmental corrosion or abrasion.

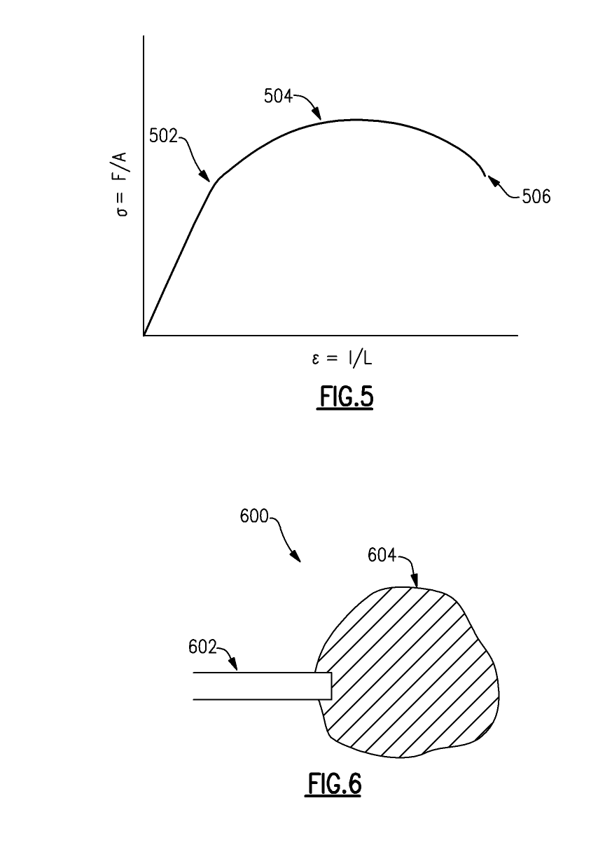

Generally, ceramics are extremely hard and tend to be very brittle. Any formed crack can therefore propagate quickly through a material with minimal extra stress. The faster a crack can propagate through a material, the lower fracture toughness the material has. Ceramics usually have low fracture toughness, especially as compared to metals. When a crack progresses through a material, a plastic zone is formed at the tip of the crack. FIG. 6 illustrates the plastic zone at the tip of a crack formation. Unlike metals, which have a relatively large plastic zone, ceramics have a limited plastic zone at the end of a crack. When a material 600 contains a crack 602, a plastic zone 604 develops at the very tip of the crack 602. As the stress and strain increase on the material, the plastic zone 604 increases in size until the crack 602 finally expands through the zone. However, the plastic zone 604 absorbs energy and leads to the dissipation of energy as heat. Therefore, the plastic zone 604 absorbs energy from the crack 602, slowing the progress of the crack 602. Metals have a large plastic zone 604, thus slowing the crack propagation, and increasing the toughness. On the other hand, ceramics have a small plastic zone 604, therefore most of the crack's energy is directed at the tip, and not the plastic zone, and the crack can propagate quickly through the ceramic material.

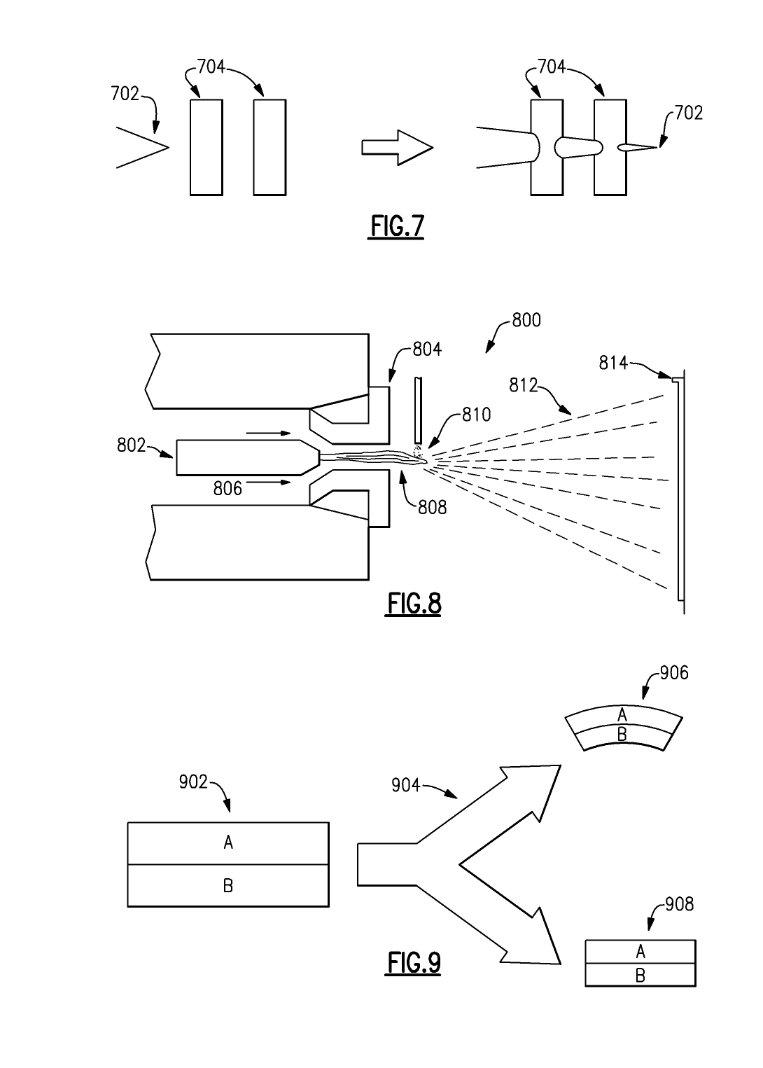

In some embodiments of the dual function coating composition, it is believed that the magnetoplumbite would form needle like crystals that can bridge cracked columns of the perovskite phase, which increases strain tolerance of the material. FIG. 7 illustrates the process in which magnetoplumbite would form the bridge across a crack zone. The crack 702 would hit the bridge 704 and stop. The crack stress would then have to circumvent around the bridge 704. After circumventing the bridge 704, the crack 702 would again begin propagating on the other side. Therefore, the crystal bridge can provide two separate functions to improve fracture toughness. First, the bridge slows down the propagation of the crack by blocking the path of the crack. Second, once the crack has progressed past the crystal bridge, the material still is connected over the crack, slowing the material from being broken apart.

### Plasma Spraying

The dual function coating composition can be plasma sprayed onto the required components. However, plasma spraying is a non-limiting example of how a dual coating composition can be added to a component. FIG. 8 illustrates an example of plasma spraying, which is a type of thermal spraying. At the most basic level, plasma spraying 800 involves spraying of molten or heat softened material onto another surface to provide a coating. A plasma sprayer uses a combination of a cathode 802 and an anode 804. Respectively, a cathode 802 and an anode 804 can be made of, but are not limited to, tungsten and copper. During plasma spraying, the cathode 802 and anode 804 need to be cooled. This can be done by, but is not limited to, water cooling. Gas 806 capable of plasma formation flows around the cathode 802 and through the anode 804. Different gasses can be used to form different heat conditions. For example, gas can be argon, nitrogen, hydrogen, or helium. Typically, the anode 804 is shaped with a small diameter opening to allow the gas 806 to be sprayed out with a high velocity. While the gas 806 is moving around the cathode 802, a high voltage is discharged, causing localized ionization and a conductive path for a DC arc to form between the cathode 802 and anode 804. The large amount of heat produced causes the gas 806 to reach an extremely high temperature and strips the gas molecules of their electrons, thus forming a plasma. The newly formed plasma exits the front of the anode. Because no combustion is actually used, low oxide coatings can be produced. The gas atoms then recombine from their plasma state, thus producing extremely high temperatures 808. Temperatures range from about 8,000° C. to about 15000° C. Powder 810 is injected into the escaping gas 806, at the exit of the anode 804. The dual function coating composition is not limited to a powder. The powder is then heated by the gas 806 and propelled 812 towards the desired surface 814, forming a coating. Upon reaching the desired surface 814, the molten drops of material flatten and solidify. The gas flow, voltage, and nozzle can all be accurately controlled, thus providing a reliable, repeatable, and consistent spray. The LnAlO₃ and LnAl₁₁O₁₈ phases each show congruent melting both individually and in a two phase assemblage, which is desirable for plasma spraying.

The material may melt congruently so that it may be plasma sprayed in the molten phase and cooled to form the desired phase assemblages. The material may have a thermal conductivity similar to or less than that of yttria stabilized zirconia. Thermal conductivity is a temperature dependent property that represents a material's ability to conduct heat. If a material has a high thermal conductivity, heat transfers across the material at a high rate, whereas a material with a low thermal conductivity would have heat transfer across the material at a low rate. Thermal conductivity is measured in watts per meter kelvin W/(mK). Thermal conductivity can be affected by, at the least, temperature, material phase, and material microstructure.

Some embodiments of the dual function coating compositions advantageously provide both thermal barrier and RF absorber properties. Some embodiments of the coating composition have magnetic activity, such as paramagnetic, ferromagnetic, or ferrimagnetic activity, at temperatures in the range of about 800° C. to about 1,000° C. The compositions may have strain tolerance when applied as a coating on a metallic turbine blade. The composition may have a thermal expansion coefficient of about 10×10⁻⁶/° C. or above. In some embodiments, the thermal expansion coefficient of the material may match or be similar to that of the metal of the aircraft engine turbine blades to which it may be applied. FIG. 9 illustrates examples of thermal expansion coefficients. When two materials are connected 902, strain 904 can be put onto the materials if their thermal expansion coefficients are not similar. If one material expands to a greater degree than the second material 906, this can cause a bend at the connection. This bend puts a strain the connection of the materials and can lead to crack formation or fracture. However, certain situations do arise where it is important to have some strain placed on the two materials. If materials have the same thermal expansion coefficient 908, they will expand at the same rate, thus reducing strain caused by the heating or cooling of the material.

### Preparation of the Modified Synthetic Garnet Compositions

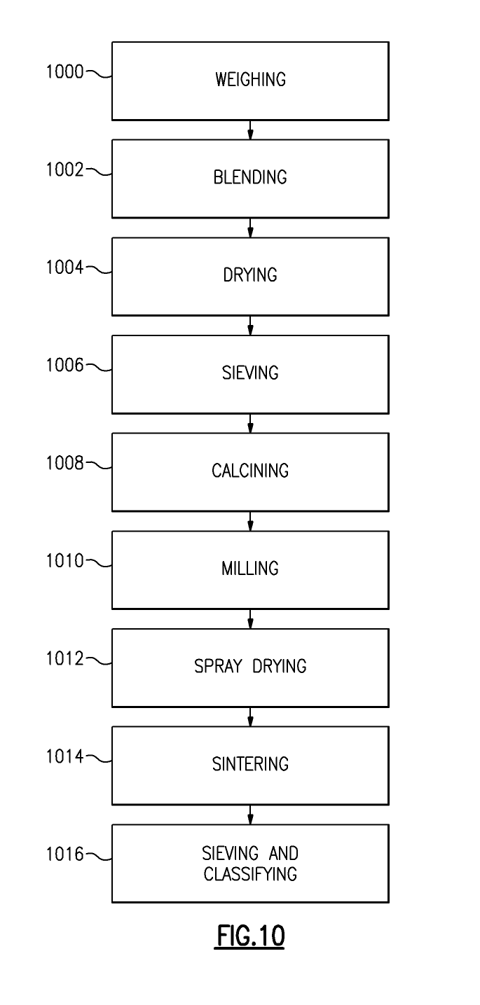

The preparation of the dual function coating composition can be accomplished by using known ceramic techniques. A particular example of the process flow is illustrated in FIG. 10.

As shown in FIG. 10, the process begins with step 1000 for weighing the raw material. The raw material may include oxides and carbonates such as Iron Oxide (Fe₂O₃), Lanthanum Oxide (La₂O₃), Aluminum Oxide (Al₂O₃), Cobalt Oxide (Co_{A}O_{B}) or combinations thereof. In addition, organic based materials may be used in a sol gel process for ethoxides or an acrylate or citrate based technique may be employed. Co-precipitation of hydroxides may also be employed as a method to obtain these materials by one skilled in the art. In addition, a glycine nitrate or spray pyrolysis technique may be used for blending and simultaneously reacting the materials.

After the raw material is weighed, they are blended in Step 1002 using methods consistent with the current state of the ceramic art, which can include aqueous blending using a mixing propeller, or aqueous blending using a vibratory mill with steel or zirconia media.

The blended oxide is subsequently dried in Step 1004, which can be accomplished by pouring the slurry into a pan and drying in an oven, preferably between about 100 to about 400° C. or by spray drying, or by other techniques known in the art.

The temperature ramp rate, the soak temperature, and the time for which the mixture is heated may be chosen depending on the requirements for a particular application. For example, if small crystal grains are desired in the material after heating, a faster temperature ramp, and/or lower soak temperature, and/or shorter heating time may be selected as opposed to an application where larger crystal grains are desired. In addition, the use of different amounts and/or forms of precursor materials may result in different requirements for parameters such as temperature ramp rate and soaking temperature and/or time to provide desired characteristics to the post-heated mixture.

The dried oxide blend is processed through a sieve in Step 1006, which homogenizes the powder and breaks up soft agglomerates that may lead to dense particles after calcining.

The material is subsequently processed through a pre-sintering calcining in Step 1008. Preferably, the material is loaded into a container such as an alumina or cordierite sagger and heat treated in the range of about 1100° C. to about 1300° C., preferably below the solidus temperature indicated on the relevant phase diagram.

After calcining, the material is milled in Step 1010, preferably in a vibratory mill, an attrition mill, a jet mill or other standard comminution technique to reduce the median particle size into the range of about 0.5 micron to about 10 microns. Milling is preferably done in a water based slurry but may also be done in ethyl alcohol or another organic based solvent. In addition, dry milling techniques such as a jet mill may be used as well. Milling may be done by any technique available to those skilled in the state of the art in ceramic processing.

The material is subsequently spray dried in Step 1012. During the spray drying process, organic additives such as binders and plasticizers can be added to the slurry using techniques known in the art. The material is spray dried to provide granules amenable to pressing, preferably in the range of about 10 microns to about 150 microns in size.

The spray dried granules are subsequently pressed in Step 1014, preferably by uniaxial or isostatic pressing to achieve a pressed density to as close to about 60% of the x-ray theoretical density as possible. The pressure used to press the material may be, for example, up to about 80,000 N/m, and is typically in the range of from about 20,000 N/m to about 60,000 N/m. A higher pressing pressure may result in a more dense material subsequent to further heating than a lower pressing pressure. In addition, other known methods such as tape casting, tape calendaring or extrusion may be employed as well to form the unfired body. Other heat treatment techniques such as induction heating may also be employed by one skilled in the art.

The pressed material may be heated on a setter plate in a periodic kiln or a tunnel kiln in air or pressure oxygen in the range of about 1100° C. to about 1400° C. to obtain a dense ceramic compact. Other known treatment techniques such as induction heat may also be used in this step.

The dense ceramic compact is sieved and classified in Step 1016 in which the powder will be sorted into the appropriate particle size range using an air classifier or a similar instrument known to those skilled in the art.

In one embodiment, the method of preparation of a coating composition may prepare a dual function coating composition represented by the formula LnAl_{1-x-y}FeₓM_{y}O₃ or LnAl_{11(1-x-y)}FeₓM_{y}O₁₈, where 0<x<1 and 0<y<0.5. In one implementation, Ln can be Lathanum (La), Praseodymium (Pr), Neodymium (Nd), Samarium (Sm), or a combination thereof; and M can be Cobalt (Co), Nickel (Ni), or Copper (Cu), or a combination thereof. In one implementation, the dual function coating material may comprise a two-phased composite of LnAl_{1-x-y}FeₓM_{y}O₃ and LnAl_{11(1-x-y)}FeₓM_{y}O₁₈. Although the parent aluminate structures LnAlO₃ and LnAl₁₁O₁₈ have been used as thermal barrier coating materials, the two-phased composite of LnAl_{1-x-y}FeₓM_{y}O₃ and LnAl_{11(1-x-y)}FeₓM_{y}O₁₈ surprisingly shows exceptional strain tolerance. It is believed that the magnetoplumbite would form needle like crystals that can bridge cracked columns of the perovskite phase, which increases strain tolerance of the material. Another advantage to the two-phased composite of LnAl_{1-x-y}FeₓM_{y}O₃ and LnAl_{11(1-x-y)}FeₓM_{y}O₁₈ is that it improves compatibility with the thermally grown aluminum oxide on bonded nickel based superalloys which are used in some aircraft engine components.

### Components Incorporating the Dual Function Coating Compositions

The dual function coating compositions made in accordance with some embodiments in this disclosure can be utilized on various metallic parts that are subject to high temperature conditions and require some form of RF absorption or scattering. The coating may serve to insulate the substrate from high heat load, allowing the substrate to operate at higher temperatures than would be possible without such a coating. These metallic parts include, but are not limited to, aircraft components, automobile components, and spacecraft components. The dual function coating composition made in accordance with some embodiments in this disclosure allow for lighter, and therefore more fuel efficient, vehicles.

FIG. 11 shows a material being exposed to high temperatures 1100. Heat 1102 is directed and reflected 1104 off of a substrate 1106 incorporating a layer of the dual function coating composition 1108 on top. The heat 1102 is reflected 1104 off of the coating 1108 to prevent the heat from reaching the underlying material. This allows the material to work at higher temperatures than if the material did not have the dual function coating composition, as the underlying material may melt at those temperatures. The substrate 1106 can be part of a military aircraft engine component such as the turbine blades. Advantageously, the single layer of dual function coating composition 1108 not only serves as a thermal barrier for the substrate 1106 but also absorbs and/or scatters RF signals, which in turn reduces the overall weight of the engine component. It will be appreciated that in various embodiments, the coating compositions can also serve other functions in addition to the dual functions described herein.

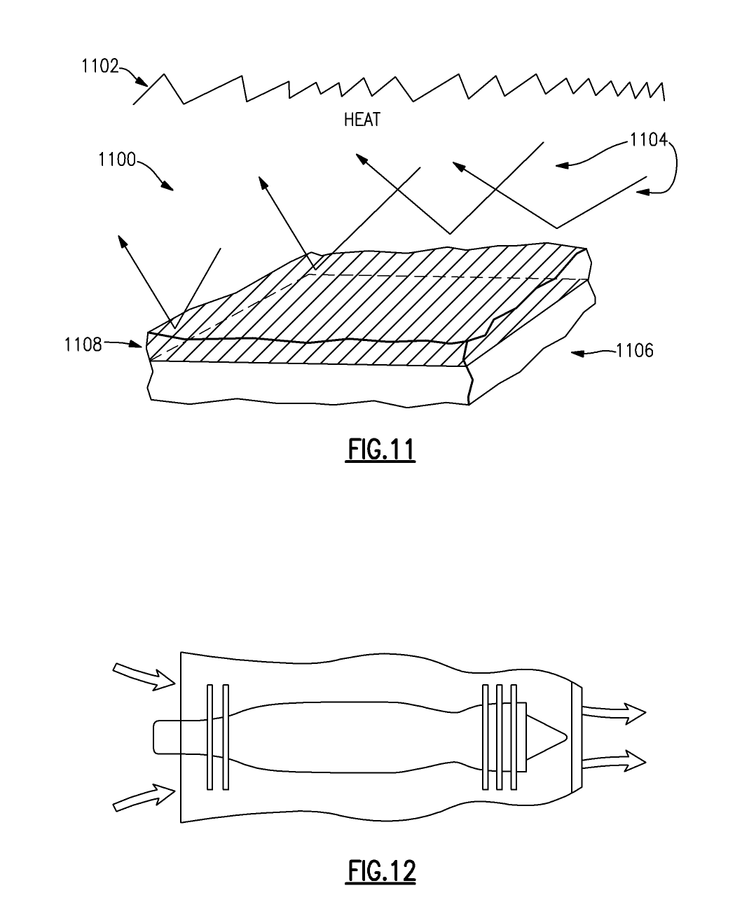

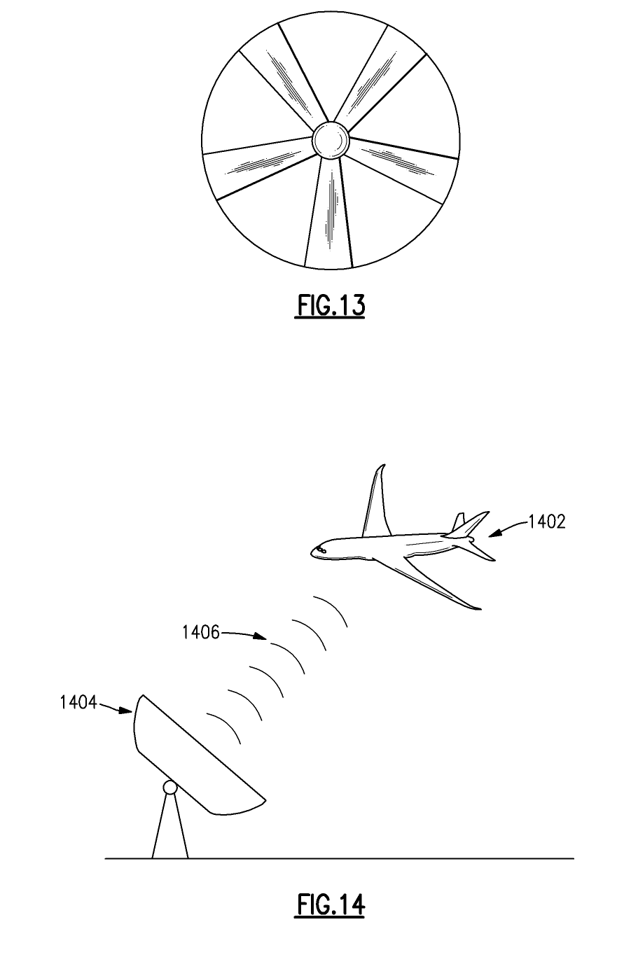

FIG. 12 illustrates a jet engine incorporating the dual function coating composition. Jet engines operate at very high temperatures, wherein these temperatures are usually well above the melting point of the materials that make up the engine. Jet engines, generally, refer to the engines used on, for example, aircrafts, missiles, and unmanned aerial vehicles. Jet engines can be created in numerous specifications, such as airbreathing and turbine powered jet engines, but all use forward thrust from jet propulsion to drive the vehicle. High temperatures are necessary to achieve greater power and fuel efficiency with the jet engine. Therefore, a thermal barrier coating is necessary for preventing the jet engine from melting while in flight, thus rending the jet airplane inoperable. Also, the thermal coating extends part life by reducing oxidation and thermal fatigue. FIG. 13 illustrates a turbine incorporating the dual function coating composition. The turbine is put into contact with hot gases that leave the combustions chamber of the direct engine. Therefore, the turbine in a jet engine experiences extremely high temperatures, thus making a thermal barrier coating a necessity.

Further, embodiments of the thermal barrier coatings may be deposited upon hot zone components in gas turbine engines (e.g., gas-turbine powered electrical generators, aero-engines, etc.). Examples of hot zone components may include, but are not limited to, combustor liners, combustor shrouds, and turbine blades. In some embodiments, the disclosed coating may be applied to components employed in automotive applications such as engine exhaust system components (e.g., exhaust manifolds, turbocharger casings, exhaust headers, downpipes, tailpipes, etc.).

As well as being a thermal barrier, the dual function coating composition acts as a RF absorber. FIG. 14 illustrates the RF absorbing properties of the dual function coating composition. Radio frequency absorbing materials, along with radar-absorbent material (RAM), are used to disguise an object from radar detection. Typically, an aircraft 1402 gives off radio frequency emissions from the devices within the aircraft, such as radar or communications systems. A ground device 1404 attempts to determine the location of a plane or other aircraft by detecting the radiofrequency 1406 that the plane gives off. However, if the plane is covered by a RF absorbing material, it will give out much less radio frequency signal. Therefore, the plane will be more difficult to discover from the ground device 1404. Also, a ground device 1404 can give off radio waves 1406 into the atmosphere. The radio waves bounce off of any objects, such as an aircraft 1402, and return to the ground device 1404. Therefore characteristics of an aircraft 1402, such as, for example, the speed, altitude, and direction, can be discovered. However, certain embodiments of the dual function coating composition absorb radio waves 1406. While radio waves cannot be completely absorbed, the dual function coating composition can limit the amount of radio waves 1406 reflected back towards the ground device 1404, therefore making it more difficult to detect the characteristics, such as speed and direction, of the aircraft 1402.

From the foregoing description, it will be appreciated that an inventive thermal barrier coatings and method of manufacturing are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A coating composition represented by the formula
LnAl_{1-x-y}FeₓM_{y}O₃, Ln being selected from the group consisting of La, Pr, Nd, Sm, and combinations thereof, and M being selected from the group consisting of Co, Ni, Cu, and combinations thereof;
wherein the coating composition provides the dual function of a thermal barrier and an RF absorber.

2. The composition of claim 1 wherein x is greater than or equal to 0 and less than or equal to 1, and y is greater than or equal to 0 and less than or equal to 0.5.

3. The composition of claim 1 wherein the composition does not form an aluminate garnet.

4. The composition of claim 1 wherein the composition has magnetic activity from temperatures in the range of about 800° C.-1,000° C.

5. The composition of claim 1 wherein the composition has a thermal expansion coefficient of about 10×10⁻⁶/° C. or above.

6. The composition of claim 1 wherein the composition has a thermal conductivity equal to or less than that of yttria stabilized zirconia.

7. An aircraft component incorporating the composition of claim 1.

8. An engine turbine blade incorporating the composition of claim 1.

9. The aircraft component of claim 7 wherein the composition has a thermal expansion coefficient matching the aircraft component.

10. The engine turbine blade of claim 8 wherein the composition has a thermal expansion coefficient matching the engine turbine blade.

11. A method of manufacturing a coating composition, the method comprising:
combining raw materials including oxides and carbonates to form a coating material;
drying the coating material;
sieving the coating material;
calcining the coating material;
milling the coating material;
spraying the coating material;
pressing coating material to form a powder having the composition LnAl_{1-x-y}FeₓM_{y}O₃, Ln being selected from the group consisting of La, Pr, Nd, Sm, and combinations thereof, and M being selected from the group consisting of Co, Ni, Cu, and combinations thereof.

12. The method of claim 11, further comprising spraying the powder onto a substrate.

13. A dual function coating composition represented by the formula
LnAl_{11(1-x-y)}FeₓM_{y}O₁₈, Ln being selected from the group consisting of La, Pr, Nd, Sm, and combinations thereof, and M being selected from the group consisting of Co, Ni, Cu, and combinations thereof;
wherein the coating composition provides the dual function of a thermal barrier and an RF absorber.

14. The composition of claim 13 wherein x is greater than or equal to 0 and less than or equal to 1, and y is greater than or equal to 0 and less than or equal to 0.5.

15. The composition of claim 13 wherein the composition does not form an aluminate garnet.

16. The composition of claim 13 wherein the composition has magnetic activity from temperatures in the range of about 800° C.-1,000° C.

17. The composition of claim 13 wherein the composition has a thermal expansion coefficient of about 10×10⁻⁶/° C. or above.

18. The composition of claim 13 wherein the composition has a thermal conductivity equal to or less than that of yttria stabilized zirconia.

19. An aircraft component incorporating the composition of claim 13.

20. An automobile engine exhaust system incorporating the composition of claim 13.
